(19) United States
(12) Patent Application Publication
(10) Pub. No.: US 2005/0197004 A1
(43) Pub. Date: Sep. 8, 2005

(54) Equipment for suspending light fittings from a ceiling or similar structure and for electrically powering them

(75) Inventors: Daniel Villeneuve, Senlis (FR); Philippe Luguet, Orgeval (FR)

Correspondence Address: OLIFF & BERRIDGE, PLC, P.O. BOX 19928, ALEXANDRIA, VA, 22320, US

(73) Assignee: WATTOHM TECHNOLOGIES, Senlis (FR)

(21) Appl. No.: 11/060,706

(22) Filed: Feb. 18, 2005

(30) Foreign Application Priority Data
Mar. 5, 2004 (FR) 04.02343

(51) Int. Cl. H01R 33/945

(52) U.S. Cl. 439/517

(57) ABSTRACT

The equipment (1) consists of a preferably metallic support (2) fixed under a ceiling or similar structure and including two longitudinal grooves (6) in which electrical conductors (71, 72, 73) extend longitudinally for powering light fittings. The light fitting (9) to be suspended and powered is fixed to or suspended from a removable mounting plate (5), provided with means (4) for attaching to the support (2), and capable of being attached to or detached from the support (2) from the ground using a pole (12) equipped with an end piece (12a) that complements a hollow part (11) of the mounting plate (5). The mounting plate (5) includes an adapter (8) electrically connected to the light fitting (9) and interacting with the electrical supply conductors (71, 72, 73) such that the attachment or detachment of the plate (5) is accompanied, respectively, by an electrical connection or disconnection of the adapter (8).

The present invention relates to equipment for the suspension of light fittings, of the “suspended lighting” type, from a ceiling or similar structure and their supply with electricity at sales outlets or exhibitions of such light fittings, for the purpose of their illuminated presentation.

Most of the equipment used in shops for suspending light fittings and simultaneously supplying them with electricity currently consist, on the one hand, of a metallic grid, widely known as an “arch”, fixed under a ceiling, from which the light fittings are suspended and on which, on the other hand, electrical supply “rails” rest, i.e. a support that includes longitudinal grooves in which extend electrical power conductors to which the light fittings are individually connected by cables.

This solution greatly complicates the tasks of electrical connection and disconnection of a light fitting as it requires the operator to ascend a ladder or stepladder in an unstable, uncomfortable position in which it is difficult to orient oneself among the multiple electrical connections and cables that may possibly be tangled up with the other light fittings and which, furthermore, poses genuine problems of electrical safety and cost.

The present invention aims to avoid these drawbacks by providing simple, modular equipment that makes it possible, simultaneously, to suspend light fittings from a ceiling or similar structure and to power them electrically, and which makes it possible, from the ground, to carry out the tasks of connection and disconnection of light fittings to and from the electrical power supply while all the while guaranteeing electrical safety.

To this end, the subject of the present invention is essentially equipment for the suspension and supply of electricity to light fittings consisting of a preferably metallic support, to be fixed under a ceiling or similar structure, and including at least one longitudinal groove in which electrical conductors extend longitudinally for powering light fittings, each light fitting to be suspended and powered being fixed to or suspended from a removable mounting plate provided with means for attaching to the support, and capable of being attached to or detached from the support from the ground using a pole equipped with an end piece complementing a hollow part of the mounting plate, the mounting plate also including an adapter provided in order to be connected electrically to the light fitting and interacting with the electrical supply conductors such that the attachment or detachment of the plate is accompanied, respectively, by an electrical connection or disconnection of the adapter.

Thus, the inventive step consists in, on the ground, connecting a light fitting of any type (pendant lamp, spot, suspended lighting, etc.) to an adapter on a mounting plate and then, from the ground, using a pole, in attaching the plate to an overhead support, automatically accompanied by the electrical connection of the adapter to electrical supply conductors of the support.

Detachment from the mounting plate also takes place from the ground, using the pole, and is accompanied by the simultaneous electrical disconnection of the adapter.

The only connections with which the operator has to concern himself in order to power the light fitting thus take place beforehand in a stable position on the ground.

Furthermore, the displacement, from one position to another on the support, of the plate and of the light fitting fixed thereto or suspended therefrom, for example in order to modify the arrangement of the light fittings, takes place rapidly, without disconnection or reconnection of any cable whatsoever, and it takes place easily because the adapter may be moved away and then re-sited at any location along the groove, each new siting thus chosen always providing electrical power in the same way.

The support is advantageously produced in the form of a metallic profiled section having a cross section that is, for example, trapezoidal, symmetrical relative to a longitudinal vertical median plane, the profiled section having, on either side of the plane, two longitudinal grooves in each of which is mounted a strip made from insulating synthetic material including longitudinal indentations acting as a housing for the electrical power conductors.

Thus, the strips electrically insulate the electrical supply conductors running along their entire length. This constitutes a discreet, safe system of electrical supply and does not adversely affect the equipment's aesthetic appeal.

Furthermore, the symmetrical structure of the support means that the whole assembly is well balanced, allows offset installation of the light fittings, in particular in the case of large-scale suspended lighting, and makes it possible for there to be illumination on two sides, in particular in the case of spots fixed to the plates.

According to one embodiment, the means for attaching the mounting plate to the support consist of a hook capable of interacting with a complementary attachment shape located at the top of the support so as to produce an articulation from which the light fitting can weigh down and thus apply electrical contacts of the adapter onto the corresponding electrical supply conductors.

Thus, with the forms chosen for the support and for the plate, the simple effect of gravity holds the plate attached to the support in position and applies the adaptor's electrical contacts onto the electrical supply conductors.

At any rate, the invention will be better understood with the aid of the following description with reference to the appended diagrammatic drawing that represents, by way of example, one embodiment of this equipment, in which;

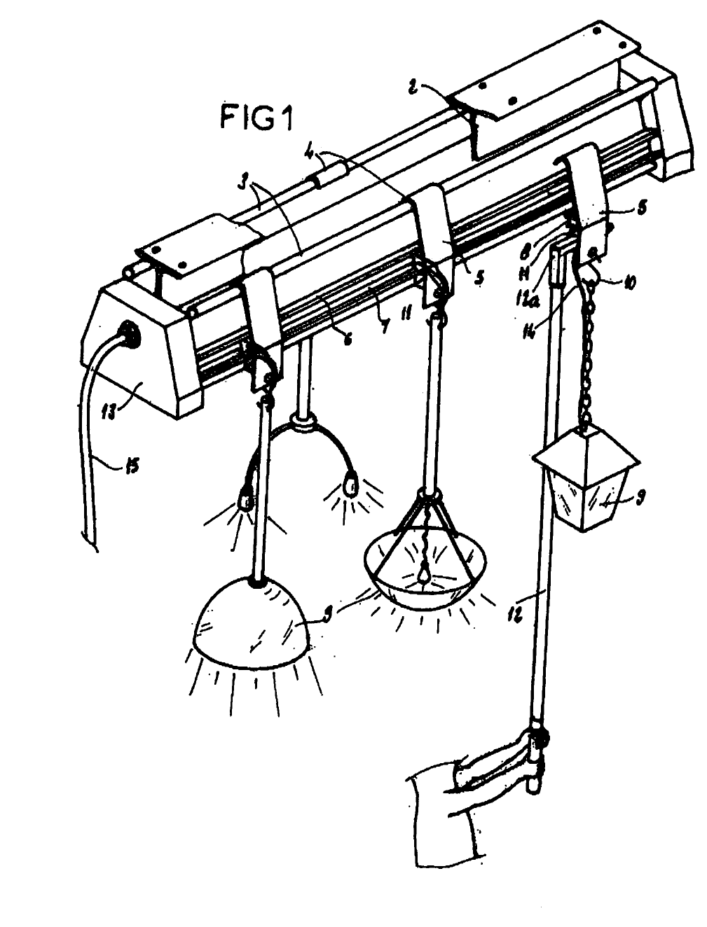

FIG. 1 is a perspective overall view of the equipment according to the present invention;

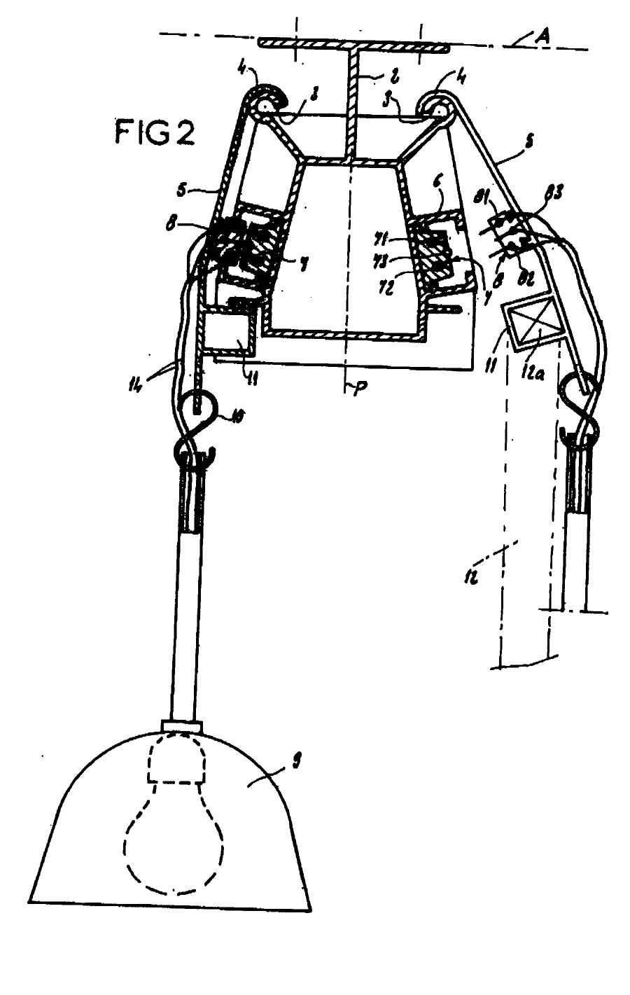

FIG. 2 is a transverse sectional view of the same equipment, indicating the mounting of an adapter.

As illustrated in FIGS. 1 and 2, the equipment 1 according to the invention consists of a support in the form of a profiled section 2 made from aluminum fixed horizontally under an “arch” A of a shop via a T-shaped fastener top flange.

The support 2 includes a tubular core of substantially trapezoidal cross section that is symmetrical relative to a median longitudinal vertical plane P and also includes two oblique flanges 3 that end in a rounded part on either side of the plane P, constituting an attachment shape, particularly for attaching removable mounting plates 5 that include, for that purpose, a hook-shaped upper part 4.

As indicated more particularly in FIG. 2, the support 2 lastly includes, on each of its sides, a longitudinal groove 6 with an outwardly open T-shaped profile in which is mounted a PVC strip 7 that includes longitudinal grooves in which extend, over the entire length, electrical supply conductors of which a neutral conductor 71, a phase conductor 72 and (at least) one ground conductor 73 are produced in the form of wires with a circular or other cross section.

The indentations of the strip 7 are open towards the inside of the groove 6 such that the electrical supply conductors 71, 72, 73 have an uncovered zone that can locally be placed in contact with other electrically conducting elements. The neutral 71 and phase 72 conductors are deeply embedded in the strip 7 so that just one suitable conductor element can come into contact with them, thus enhancing safety, while the ground conductor 73 is slightly proud in order to facilitate contact with any conducting object such as, in particular, an electrical adapter, which would be inserted in the groove 6: this arrangement further enhances equipment safety.

Each mounting plate 5 is provided with an electrical adapter 8 provided with electrical contacts 81, 82, 83 interacting with the electrical supply conductors 71, 72, 73 such that attachment to or detachment from the plate 5 is accompanied, respectively, by an electrical connection or disconnection of the adapter 8. The adapter 8 may be moved away and then resited at any location along the length of the grooves 6, each new siting thus chosen always providing electrical power in the same way.

When the equipment is in use, suspended lighting 9 is suspended, for example by means of a hook 10 or any other known means, from one of the plates 5. The suspended lighting 9 weighs down on the articulation formed by the hook 4 and the oblique flange 3, between the support 2 and its plate 5. Owing to the trapezoidal shape and the lateral inclination of the support 2, the weight of the suspended lighting 9 applies the neutral 81, phase 82 and ground 83 electrical contacts of the adapter 8 onto the corresponding electrical supply conductors 71, 72, 73.

The suspended lighting 9 is connected to the contacts 81, 82, 83 of the adapter 8 by electrical connections in the form of simple wires 14.

The mounting plate 5 includes, on the inside, a tubular lower part 11 of hollow cross section, for example of square cross section, allowing it to be attached to the support 2 or detached therefrom from the ground using a pole 12 equipped with an end piece 12a of corresponding cross section with a tapered end for insertion in the part 11.

General electrical powering of the equipment must, of course, provide electric current to the conductors 71, 72, 73 inserted in the various grooves 6. This general powering is achieved by means of a specific end cap 13 at one end of the support 2 and connected to the mains supply by means of a mains-connection cable 15. The contour of the cap 13 corresponds to the envelope of the cross section of the profiled section 2.

It would not constitute a departure from the scope of the present invention as defined in the appended claims, to, in particulars
modify the details of form of the profiled section forming the support 2;
replace the suspended lighting 9 with any type of light fitting, such as an adjustable spot, etc.;
apply the invention to any electrical power supply application requiring mobility and installation from the ground.

1. Equipment for the suspension and supply of electricity to light fittings consisting of a preferably metallic support, to be fixed under a ceiling or similar structure, and including at least one longitudinal groove in which electrical conductors extend longitudinally for powering light fittings, characterized in that each fitting to be suspended and powered is fixed to or suspended from a removable mounting plate provided with means for attaching to the support, and capable of being attached to or detached from the support from the ground using a pole equipped with an end piece complementing a hollow part of the mounting plate, the mounting plate also including an adapted provided in order to be connected electrically to the light fitting and interacting with the electrical supply conductors such that the attachment or detachment of the plate is accompanied, respectively, by an electrical connection or disconnection of the adapter.

2. Equipment according to claim 1, characterized in that the support is produced in the form of a metallic profiled section having a cross section that is, for example, trapezoidal, symmetrical relative to a longitudinal vertical median plane, the profiled section having, on either side of the plane, the profiled section, two longitudinal grooves in each of which is mounted a strip made from insulating synthetic material including longitudinal indentations acting as a housing for the electrical power conductors.

3. Equipment according to claim 1, characterized in that the means for attaching the mounting plate to be the support consist of a hook capable of interacting with a complementary attachment shape located at the tope of the support so as to produce an articulation from which the light fitting can weigh down and thus apply electrical contacts of the adapter onto the corresponding electrical supply conductors.

4. Equipment according to claim 2, characterized in that the means for attaching the mounting plate to be the support consist of a hook capable of interacting with a complementary attachment shape located at the tope of the support so as to produce an articulation from which the light fitting can weigh down and thus apply electrical contacts of the adapter onto the corresponding electrical supply conductors
